(19) United States
(12) Patent Application Publication
(10) Pub. No.: US 2017/0201757 A1
(43) Pub. Date: Jul. 13, 2017

(54) VIDEO DATA ENCODING AND DECODING

(71) Applicant: SONY CORPORATION, Tokyo (JP)

(72) Inventors: Michael GOLDMAN, London (GB); David WAGG, Basingstoke (GB); Michael John WILLIAMS, Winchester (GB); Karl James SHARMAN, East Ilsley (GB)

(73) Assignee: SONY CORPORATION, Tokyo (JP)

(21) Appl. No.: 15/324,747

(22) PCT Filed: Jun. 25, 2015
(86) PCT No.: PCT/GB2015/051848

§ 371 Date: Jan. 9, 2017

(30) Foreign Application Priority Data
Sep. 30, 2014 (GB) 1417274.6

(51) Int. Cl. H04N 19/169; H04N 19/46; H04L 29/06; H04N 19/177

(52) U.S. Cl. CPC H04N 19/188; H04N 19/177; H04N 19/46; H04L 65/602

(57) ABSTRACT

A video data encoding method is operable with respect to successive source images each including a set of encoded regions, each region being separately encoded as an independently decodable network abstraction layer (NAL) unit having associated encoding parameter data. The method includes: identifying a subset of the regions representing at least a portion of each source image that corresponds to a required display image; allocating regions of the subset of regions for a source image to respective composite frames of a set of one or more composite frames so that the set of composite frames, taken together, provides image data representing the subset of regions; and modifying the encoding parameter data associated with the regions allocated to each composite frame so that the encoding parameter data corresponds to that of a frame comprising those regions allocated to that composite frame.

### FIELD OF THE DISCLOSURE

This disclosure relates to video data encoding and decoding.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

As production technology advances to 4K and beyond, it is increasingly difficult to transmit content to end-users at home. 4K video indicates a horizontal resolution of about 4000 pixels, for example 3840×2160 or 4096×2160 pixels. Some applications have even proposed an 8K by 2K video (for example, 8192×2160 pixels), produced by electronically stitching two 4K camera sources together. An example of the use of such a video stream is to capture the entire field of view of a large area such as a sports stadium, offering an unprecedented overview of live sports events.

At the priority date of the present application, it is not yet technically feasible to transmit an 8K by 2K video to end-users over the internet due to data bandwidth restrictions. However, HD video (720p or 1080p) video is widely available in formats such as the H.264/MPEG-4 AVC or HEVC standards at bit-rates between (say) 5 and 10 Mb/s. A proliferation of mobile devices capable of displaying HD video makes this format attractive for “second screen” applications, accompanying existing broadcast coverage. Here, a “second screen” implies a supplementary display, for example on a mobile device such as a tablet device, in addition to a “main screen” display on a conventional television display. Here, the “second screen” would normally display images at a lower pixel resolution than that of the main image, so that the second screen displays a portion of the main image at any time. Note however that a “main” display is not needed; these techniques are relevant to displaying a selectable or other portion of a main image whether or not the main image is in fact displayed in full at the same time.

In the context of a “second screen” type of system, it may therefore be considered to convey a user-selectable or other sub-portion of a main image to the second screen device, independently of whether the “main image” is actually displayed. The terms “second screen image” and “second screen device” will be used in the present application in this context.

One previously proposed system for achieving this pre-encodes the 8K stitched scene image (the main image in this context) into a set of HD tiles, so that a subset of the tiles can be transmitted as a sub-portion to a particular user. Given that such systems allow the user to select the portion for display as the second screen, there is a need to be able to move from one tile to the next. To achieve this smoothly, this previously proposed system allows for the tiles to overlap significantly. This causes the number of tiles to be high, requiring a large amount of storage and random access memory (RAM) usage on the server handling the video data. For example, in an empirical test when encoding HD tiles to AVC format at 7.5 Mb/s, one dataset covering a soccer match required approximately 7 GB of encoded data per minute of source footage, in an example arrangement of 136 overlapping tiles. An example basketball match using 175 overlapping tiles required approximately 9 GB of encoded data per minute of source footage.

### SUMMARY

This disclosure provides a video data encoding method operable with respect to successive source images each comprising a set of encoded regions, each region being separately encoded as an independently decodable network abstraction layer (NAL) unit having associated encoding parameter data; the method comprising:

identifying a subset of the regions representing at least a portion of each source image that corresponds to a required display image;

allocating regions of the subset of regions for a source image to respective composite frames of a set of one or more composite frames so that the set of composite frames, taken together, provides image data representing the subset of regions; and

modifying the encoding parameter data associated with the regions allocated to each composite frame so that the encoding parameter data corresponds to that of a frame comprising those regions allocated to that composite frame.

This disclosure also provides a video data encoding method operable with respect to successive source images each comprising a set of encoded regions, each region being separately encoded as an independently decodable network abstraction layer (NAL) unit having associated encoding parameter data; the method comprising:

identifying a subset of the regions representing at least a portion of each source image that corresponds to a required display image;

allocating regions of the subset of regions for a source image to respective composite frames of a set of one or more composite frames so that the set of composite frames, taken together, provides image data representing the subset of regions; and

modifying the encoding parameter data associated with the regions allocated to each composite frame so that the encoding parameter data corresponds to that of a frame comprising those regions allocated to that composite frame.

This disclosure also provides a video decoding method comprising:

receiving a set of one or more input composite frames, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;

decoding each input composite frame; and

generating the display image from a decoded input composite frame.

Further respective aspects and features are defined in the appended claims.

It is to be understood that both the foregoing general description and the following detailed description are exemplary, but not restrictive of, the present disclosure.

This disclosure also provides a method of operation of a video client device comprising:

receiving a set of one or more input composite frames from a server, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;

decoding each input composite frame;

generating the display image from a decoded input composite frame; and

in response to a user input, sending information to the server indicating the extent, within the source image, of the required display image.

The disclosure recognises that the volume of encoded data generated by the previously proposed arrangement discussed above implies that an alternative technique could reduce the server requirements and reduce the time required to produce the tiled content (or more generally, content divided in regions).

One alternative approach to encoding the original source would be to divide it up into a larger array (at least in some embodiments) of smaller non-overlapping tiles or regions, for example an n×m array of regions where at least one of n and m is greater than one, and send a sub-array of tiles or regions to a particular device (such as a second screen device) that covers the currently required display image. As discussed above, in examples where the sub-portion for display on the device is selectable, as the user pans the sub-portion across the main image, tiles no longer in view are discarded from the sub-array and tiles coming into view are added to the sub-array. The lack of overlap between tiles can reduce the server footprint and associated encoding time. Having said this, while there is no technical need, under the present arrangements, to overlap the tiles, the arrangements do not necessarily exclude configurations in which the tiles are at least partially overlapped, perhaps for other reasons.

However, the disclosure recognises that there are potentially further technical issues in decoding multiple bitstreams in parallel on current mobile devices. Mobile devices such as tablet devices generally rely on specialised hardware to decode video, and this restricts the number of video bitstreams that can be decoded in parallel. For example, the Sony® Xperia® Tablet Z™, 3 video decoders can be operated in parallel. In an example arrangement of tiles with size 256 by 256 pixels and a 1080p video format for transmission to the mobile device, under the AVC system 40 tiles and therefore 40 parallel decoding streams would be required, corresponding to a transmitted image size of 2048 by 1280 pixels so as to encompass the required 1080p format. Such a number of parallel decoding streams cannot currently be handled on mobile devices.

Embodiments of the present disclosure both recognises and addresses this issue.

According to the present disclosure, instead of sending 40 individual tile streams, the tile data is repackaged into slice data and placed in a smaller number of one or more larger bitstreams. Metadata associated with the tiles is modified so that the final bitstream is fully compliant with a video standard (such as the H.264/MPEG4 standard, otherwise known as the Advanced Video Coding or AVC standard, though the techniques are equally applicable to other standards such as MPEG2 or H.265/HEVC), and therefore to the decoder on the mobile device the bitstream(s) appears to be quite normal. The repackaging does not involve re-encoding the tile data, so a required output bitstream can be produced quickly.

### BRIEF DESCRIPTION OF THE DRAWINGS

A more complete appreciation of the disclosure and many of the attendant advantages thereof will be readily obtained as the same becomes better understood by reference to the following detailed description of embodiments, when considered in connection with the accompanying drawings, wherein:

FIG. 1 is a schematic diagram of a video encoding and decoding system;

FIGS. 2 to 4 schematically illustrate the selection of tiles within a tiled image;

FIG. 5 schematically illustrates a client and server arrangement;

FIG. 6 schematically illustrates the selection of a sub-portion of an image;

FIGS. 7a and 7b schematically illustrate a repackaging process;

FIG. 8 schematically illustrates a sub-array of tiles;

FIG. 9 schematically illustrates a tile and associated metadata;

FIG. 10 schematically illustrates a composite image;

FIG. 11 schematically illustrates a set of composite images;

FIG. 12 is a schematic flowchart illustrating aspects of the operation of a video server;

FIG. 13 is a schematic flowchart illustrating a repackaging process;

FIG. 14 is a schematic flowchart illustrating aspects of the operation of a video client device;

FIG. 15 schematically illustrates the use of a video buffer at a client device; and

FIG. 16 schematically illustrates a data processing apparatus;

FIG. 17 schematically illustrates a video encoding method;

FIGS. 18 and 19 schematically illustrate source image division examples.

### DESCRIPTION OF THE EMBODIMENTS

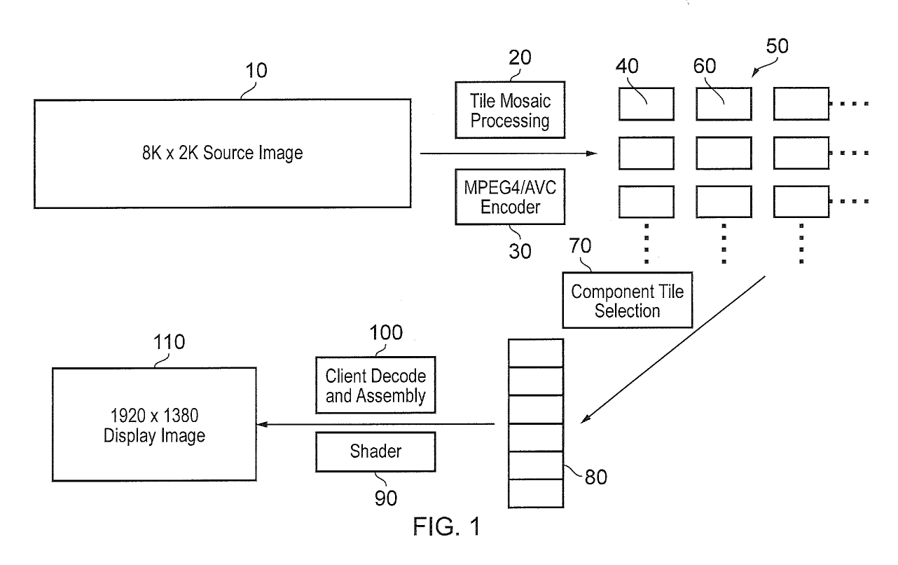

Referring now to the drawings, FIG. 1 is a schematic diagram of a video encoding and decoding system. The system is shown acting in respect of an 8K×2K (for example, 8192 pixels×2160 pixels) source image 10, which for example may be generated (by image generation apparatus not shown) by stitching together (combining so that one is next to the other) two 4K images. The 4K images may be obtained by a pair of laterally angularly displaced 4K cameras such that the fields of view of the two cameras abut one another or very slightly overlap such that a single 8K wide image can be generated from the two captured 4K images. Nevertheless, neither the provenance of the original source image 10 nor its size are of technical relevance to the technology which will be discussed below.

The source image 10 is subject to tile mosaic processing 20 and video encoding, for example by an MPEG 4/AVC encoder 30. Note that other encoding techniques are discussed below, and note also that AVC is merely an example of an encoding technique. The present embodiments are not restricted to AVC, HEVC or any other encoding technique. The tile mosaic processing 20 divides the source image 10 into an array of tiles. The tiles do not overlap (or at least do not need, according to the present techniques, to overlap), but are arranged so that the entire array of tiles encompasses at least the whole of the source image, or in other words so that every pixel of the source image 10 is included in exactly one of the tiles. In at least some embodiments, the tiles are all of equal size, but this is not a requirement, such that the tiles could be of different sizes and/or shapes. In other words, the expression “an array” of tiles may mean a regular array, but could simply mean a collection of tiles such that, taken together, the tiles encompass, at least once, each pixel in the source image. Each tile is separately encoded into a respective network abstraction layer (NAL) unit.

Note that the tiles are simply examples of image regions. In various embodiments, the regions could be tiles, slices or the like. In examples an n×m set of tiles may be used, but note that it may be (in some examples) that only one of n and m is greater than one. Or both of n and m could be greater than one.

The source image 10 is in fact representative of each of a succession of images of a video signal. Each of the source images 10 in the video signal has the same pixel dimensions (for example, 8192×2160) and the division by the tile mosaic processing 20 into the array of tiles may be the same for each of the source images. So, for any individual tile position in the array of tiles, a tile is present in respect of each source image 10 of the video signal. Of course, the image content of the tiles corresponding to successive images may be different, but the location of the tiles within the source image and their size will be the same from source image to source image. In fact, the MPEG 4/AVC encoder 30 acts to encode a succession of tiles at the same tile position as though they were a stream of images. So, taking the top-left tile 40 of the array of tiles 50 as an example, a group of pictures (GOP)-based encoding technique may be used so as to provide image compression based upon temporal and spatial redundancy within a group of successive top-left tiles. An independent but otherwise similar technique is used to encode successive instances of other tiles such as a tile 60. The fact that each tile of each source image is encoded as a separate NAL unit implies that each tile of each source image may be independently decoded (subject of course to any temporal interdependencies at a particular tile position introduced by the GOP-based encoding technique). In some embodiments, the tiles are encoded using a GOP structure that does not make use of bidirectional (B) dependencies. The tiles may all be of the same pixel dimensions.

As an example, in the case of an 8K×2K source image, a division may be made into tiles which are 256×256 pixels in size, such that the source image 10 is divided into 32 tiles in a horizontal direction by 9 tiles in a vertical direction. Note that 9×256=2304, which is larger than the vertical size of the example image (2160 pixels); the excess space may be split evenly between the top and the bottom of the image and may contain blank (such as black) pixels. The total number of tiles in this example is 288.

Therefore, at each of the 288 tile positions in the array 50, a separately decodable video stream is provided. In principle this allows any permutation of different tiles to be transmitted to a client device and decoded for display there. In fact, a contiguous rectangular sub-array of the tiles is selected for transmission to the client device in this example, as indicated schematically by a process 70. The sub-array may, for example, represent a 2K×1K sub portion of the original source image 10. To encompass such a sub portion, a group of tiles is selected so as to form the sub-array. For example, this sub-array may encompass 8 tiles in the horizontal direction and 5 tiles in the vertical direction. Note that 5 rather than 4 tiles are used in the vertical direction to allow a 1080 pixel-high image to be displayed at the client side, if required. If only 4 tiles were selected in a vertical direction this would provide a 1024 pixel-high image. However, it will be appreciated that the size of the selected sub-array of tiles is a matter of system design. The technically significant feature is that the sub-array is a subset, for example a contiguous subset, containing fewer tiles than the array 50.

For transmission to the client device, the tiles of the sub-array of tiles may be re-ordered or re-packaged into composite picture packages (CPPs). The purpose and use of CPPs will be discussed below in more detail, but as an overview, the sub-array of tiles for a source image is packaged as a CPP so that tiles from a single source image are grouped together into a respective CPP. The CPP in turn contains one or more composite frames, each composite frame being handled (for the purposes of decoding at the decoder) as though it were a single frame, but each composite frame being formed of multiple slices, each slice containing a respective tile. In at least some embodiments, the CPP contains multiple composite frames in respect of each source image.

At the decoder, one CPP needs to be decoded to generate one output “second screen” image. Therefore in arrangements in which a CPP contains multiple composite frames, the decoder should decode the received data a corresponding multiple of times faster than the display image rate. Once the CPP has been decoded, the decoded tiles of the sub-array are reordered, for example using a so-called shader, into the correct sub-array order for display.

Accordingly the encoding techniques described here provide examples of a video data encoding method operable with respect to successive source images each comprising an array of n×m encoded tiles, where n and m are respective integers at least one of which is greater than one, each tile being separately encoded as an independently decodable network abstraction layer (NAL) unit having associated encoding parameter data. At the decoder side, the techniques described below provide an example of receiving a set of one or more input composite frames, each input composite frame comprising an array of image tiles one tile wide by p tiles high, each tile being separately encoded as an independently decodable network abstraction layer (NAL) unit, in which the tiles provided by the set of input frames, taken together, represent at least a portion, corresponding to a required display image, of a source image of a video signal comprising an array of n×m tiles, where n and m are respective integers at least one of which is greater than one. This also provides an example of a video decoding method comprising: receiving a set of one or more input composite frames, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions; decoding each input composite frame; and generating the display image from a decoded input composite frame.

A schematic example 80 of a CPP is shown in FIG. 1. Successive CPPs, containing one or more, depending on the format used, composite frame for each source image 10, are sent from the video source to the client device at which, using a shader 90 and a decoding and assembly process 100, the tiles are retrieved and decoded from the CPP(s) and reassembled into, for example, an HD display image (such as a second screen image) 110 of 1920×1080 pixels.

Note that the system as described allows different client devices to receive different sub-arrays so as to provide different respective “second screen” images at those client devices. The encoding (by the stages 20 and 30) takes place once, for all of the tiles in the array 50. But the division into sub-arrays and the allocation of tiles to a CPP can take place in multiple different permutations of tiles, so as to provide different views to different client devices. Of course, if two or more client devices require the same view, then they could share a common CPP stream. In other words, the selection process 70 does not necessarily have to be implemented separately for every client device, but could simply be implemented once in respect of each required sub-array.

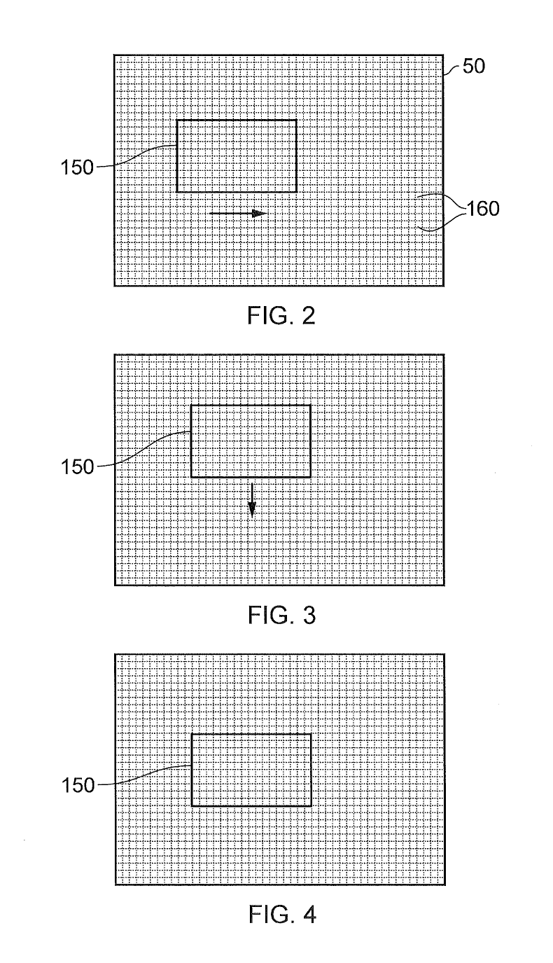

FIGS. 2 to 4 schematically illustrate the selection of tiles within a tiled image. In FIGS. 2 to 4, a rectangular sub-array 150 of tiles 160 is shown as a selection from the array 50 of tiles. As discussed above, the number of tiles in the array 50 and the number of tiles in the sub-array 150 are a matter of system design, and arbitrary numbers are shown in the context of the drawings of FIGS. 2 to 4.

A feature of the present embodiments is that the portion of the source image 10 represented by the sub-portion corresponding to the sub-array 150 may be varied. For example, the position of the sub-array 150 within the array 50 may be varied in response to commands made by a user of the client device who is currently viewing the display image 110. In particular, the position of the sub-array 150 may be moved laterally and/or vertically within the array 50. FIG. 3 schematically illustrates the situation after a lateral movement to the right has been made with respect to the sub-array position of FIG. 2. FIG. 4 schematically illustrates the situation after a further vertical movement downwards has been made with respect to the sub-array position of FIG. 3. To the viewer of the display image 110, the impression given is that of a viewing window onto a larger image which the viewer may move around at will. In some embodiments, the viewer or user of the client device may zoom into the display image using a client-side digital zoom process. The use of user controls at the client device will be discussed further with reference to FIG. 6 below and provides an example of the client device, in response to a user input, sending information to the server indicating the extent, within the source image, of the required display image.

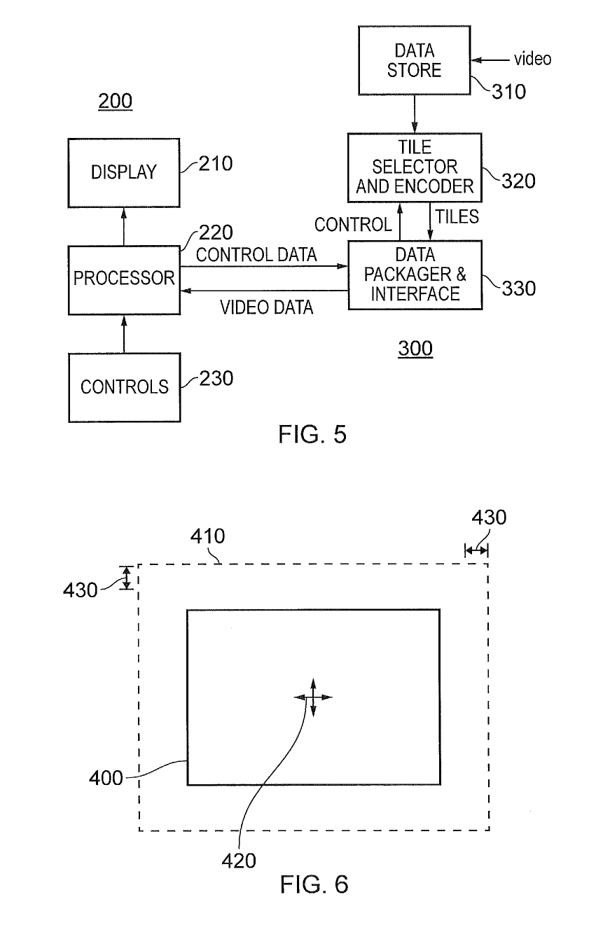

FIG. 5 schematically illustrates a client and server arrangement. In FIG. 5, the client device 200 is shown to the left side of the drawing and the server device 300 is shown to the right side of the drawing. The client device 200 and the server device 300 may be connected by, for example, a network, wireless, Internet or other data communication path. It will be understood that more than one client device 200 may be connected simultaneously to the server 300 such that the server 300 responds individually to each such client device 200. For the sake of the present discussion, only one client device 200 will be considered.

The client device 200 comprises, potentially amongst other features, a display 210 on which the display image 110 may be displayed, a processor 220 and one or more user controls 230 such as, for example, one or more buttons and/or a touch screen or other touch-based interface.

The server device 300 comprises, potentially amongst other features, a data store 310 operable to receive and buffer successive source images 10 of an input video signal, a tile selector and encoder 320 operable to carry out the processes 20, 30 and 70 of FIG. 1, and a data packager and interface 330 operable to carry out the generation of the CPPs 80.

The client device 200 operates according to the techniques described here to provide an example of a video decoder comprising:

a data receiver configured to receive a set of one or more input composite frames, each input composite frame comprising an array of image tiles one tile wide by p tiles high, each tile being separately encoded as an independently decodable network abstraction layer (NAL) unit, in which the tiles provided by the set of input composite frames, taken together, represent at least a portion, corresponding to a required display image, of a source image of a video signal comprising an array of n×m tiles, where n and m are respective integers at least one of which is greater than one;

a decoder configured to decode each input frame; and

an image generator configured to generate the display image by reordering the tiles of the decoded input composite frames.

The client device 200 operates according to the techniques described here to provide an example of a video decoder comprising:

a data receiver configured to receive a set of one or more input composite frames, each input composite frame comprising a group of image regions, each region being separately encoded as an independently decodable network abstraction layer (NAL) unit, in which the regions provided by the set of input composite frames, taken together, represent at least a portion, corresponding to a required display image, of a source image of a video signal comprising a set of regions;

a decoder configured to decode each input frame; and

an image generator configured to generate the display image from a decoded input frame.

The server device 300 operates according to the techniques described here to provide an example of video data encoding apparatus operable with respect to successive source images each comprising an array of n×m encoded tiles, where n and m are respective integers at least one of which is greater than one, each tile being separately encoded as an independently decodable network abstraction layer (NAL) unit having associated encoding parameter data; the apparatus comprising:

a sub-array selector configured to identify (for example, in response to an instruction from a client device) a sub-array of the tiles representing at least a portion of each source image that corresponds to a required display image;

a frame allocator configured to allocate tiles of the sub-array of tiles for a source image to respective composite frames of a set of one or more composite frames so that the set of composite frames, taken together, provides image data representing the sub-array of tiles, each output frame comprising an array of the tiles which is one tile wide by p tiles high, where p is an integer greater than one; and

a data modifier configured to modify the encoding parameter data associated with the tiles allocated to each composite frame so that the encoding parameter data corresponds to that of a frame of 1×p tiles.

The server device 300 operates according to the principles described here to provide an example of video data encoding apparatus operable with respect to successive source images each comprising a set of encoded regions, each region being separately encoded as an independently decodable network abstraction layer (NAL) unit having associated encoding parameter data; the apparatus comprising:

a subset selector (such as the tile selector and encoder 320) configured to identify a subset of the regions representing at least a portion of each source image that corresponds to a required display image;

a frame allocator (such as the tile selector and encoder 320) configured to allocate regions of the subset of regions for a source image to respective composite frames of a set of one or more composite frames so that the set of composite frames, taken together, provides image data representing the subset of regions, each output frame comprising a subset of the regions; and

a data modifier (such as either of the data packager and interface 330 or the tile selector and encoder 320) configured to modify the encoding parameter data associated with the regions allocated to the composite frames so that the encoding parameter data corresponds to that of a frame comprising those regions allocated to that composite frame.

In operation, successive source images 10 of an input video signal are provided to the data store 310. They are divided into tiles and encoded, and then tiles of a sub-array relevant to a currently required display image 110 are selected (by the tile selector and encoder 320) to be packaged into respective CPPs (that is to say, one CPP for each source image 10) by the data packager and interface 330. At the client side, the processor 220 decodes the CPPs and reassembles the received tiles into the display image for display on the display 210.

The controls 230 allow the user to specify operations such as panning operations so as to move the sub-array 150 of tiles within the array 50 of tiles, as discussed with reference to FIGS. 2 to 4. In response to such commands issued by the user of the client device 200, the client device sends control data to the server device 300 which is used to control operation of the tile selector and encoder 320. The data path from the server 300 to the client 200 carries at least video data. It will of course be understood that the video data may be accompanied by other information such as audio data and metadata such as subtitling information, but for clarity of the diagram these are not shown.

Using the controls 230 in this way, the client device 200 provides an example of a video client device comprising: a data receiver configured to receive a set of one or more input composite frames from a server, each input composite frame comprising a group of image regions, each region being separately encoded as an independently decodable network abstraction layer (NAL) unit, in which the regions provided by the set of input composite frames, taken together, represent at least a portion, corresponding to a required display image, of a source image of a video signal comprising a set of regions; a decoder configured to decode each input frame; an image generator configured to generate the display image from a decoded input frame; and a controller, responsive to a user input, configured to send information to the server indicating the extent, within the source image, of the required display image. The techniques as described provide an example of a method of operation of such a device.

FIG. 6 schematically illustrates the selection of a sub-portion of an image by a user of the client device 200.

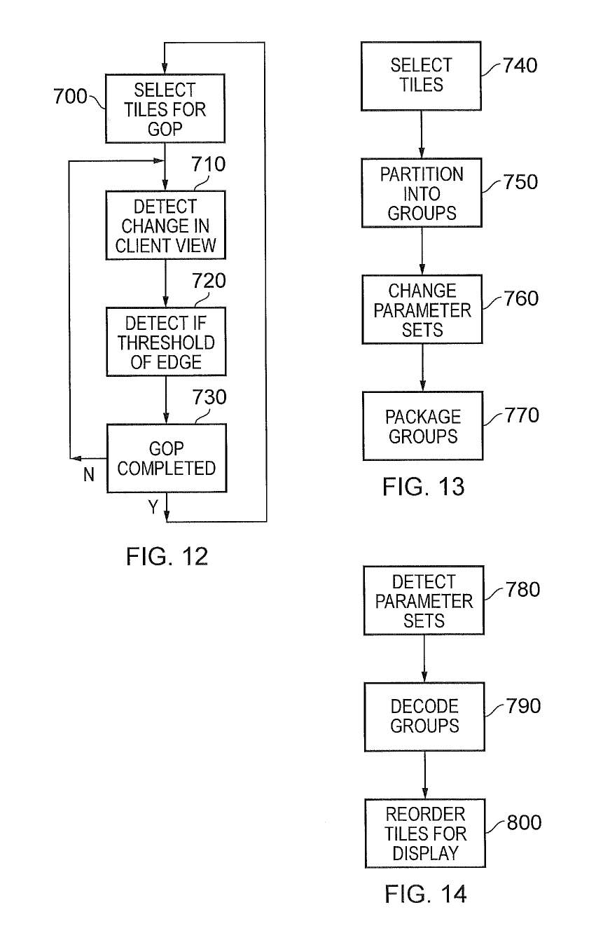

As discussed above, a basic feature of the apparatus is that the user may move or pan the position of the sub-array 150 within the array 50 so as to move around the extent of the source image 10. To achieve this, user controls are provided at the client device 200, and user actions in terms of panning commands are detected and (potentially after being processed as discussed below with reference to FIG. 12) are passed back in the form of control data to the server device 300.

In some embodiments, the arrangement is constrained so that changes to the cohort of tiles forming the sub-array 150 are made only at GOP boundaries. This is an example of an arrangement in which the source images are encoded as successive groups of pictures (GOPs); the identifying step (of a sub-array of tiles) being carried out in respect of each GOP so that within a GOP, the same sub-array is used in respect of each source image encoded by that GOP. This is also an example of a client device issuing an instruction to change a selection of tiles included in the array, in respect of a next GOP. Note however that the change applied at a GOP boundary can be derived before the GOP boundary, for example on the basis of the state of a user control a short period (such as less than one frame period) before the GOP boundary.

In some examples, a GOP may correspond to 0.5 seconds of video. So, changes to the sub-array of tiles are made only at 0.5 second intervals. To avoid this creating an undesirable jerkiness in the response of the client device, various measures are taken. In particular, the image 110 which is displayed to the user may not in fact encompass the full extent of the image data sent to the client device. In some examples, sufficient tiles are transmitted that the full resolution of the set of tiles forming the sub-array is greater than the required size of the display image. For example, in the case of a display image of 1920×1080 pixels, in fact 40 tiles (8×5) are used as a sub-array such that 2048×1280 pixels are sent by each sub-array. This provides a small margin such that within a particular set of tiles forming a particular sub-array (that is to say, during a GOP) a small degree of panning is permissible at the client device without going beyond the pixel data being supplied by the server 300. This is an example of detecting the sub-array of tiles so that the part of the source image represented by the sub-array is larger than the detected portion. To increase the size of this margin, one option is to increase the number of tiles sent in respect of each instance of the sub-array (for example, to 9×6 tiles). However, this would have a significant effect on the quantity of data, and in particular the amount of normally redundant data, which would have to be sent from the server 300 to the client 200. Accordingly, in some embodiments, the image as displayed to the user is in fact a slightly digitally zoomed version of the received image from the server 300. If, for example, a 110% zoom ratio is used, then in order to display an apparent 1920×1080 pixel display image, only 1745×982 received pixels are required. This allows the user to pan the displayed image by slightly more than 10% of the width or height of the displayed image (slightly more because the 8×5 tile image was already bigger than 1920×1080 pixels) while remaining within the same sub-array.

In normal use, it is expected that a pan of 10% of the width or height of the displayed image in 0.5 seconds would be considered a rapid pan, but this rate of pan may easily be exceeded. Of course, if this rate of pan is exceeded, then in the remaining time before the next GOP, blanking or background pixels (such as pixels forming a part of a pre-stored background image in the case of a static main image view of a sports stadium, for example) may be displayed in areas for which no image data is being received.

Referring to FIG. 6, the slightly zoomed display image 400 is shown within a broken line rectangle 410 indicating the extent of the decoded received sub-array. In some examples, the user may use a touch screen control and a finger-sliding action to pan the image 400 around the available extent 410.

If the user makes merely very small panning motions within the time period of a GOP, the system may determine that no change to the sub-array of tiles is needed in respect of the next GOP. However, if the user pans the image 400 so as to approach the edge of the extent 410 of the current sub-array, then it may be necessary that the sub-array is changed in respect of the next GOP. For example, if the user makes a panning motion such that the displayed image 400 approaches to within a threshold distance 430 of a vertical or horizontal edge of the extent 410, then the sub-array 150 may be changed at the next GOP so as to add a row or column of additional tiles at the edge being approached and to discard a row or column of tiles at the opposite edge.

The use of the panning controls in this way provides an example of indicating, to the server, the extent (within the source image) of a required display image, even if the entire display image is not actually displayed (by virtue of the zooming mechanism discussed).

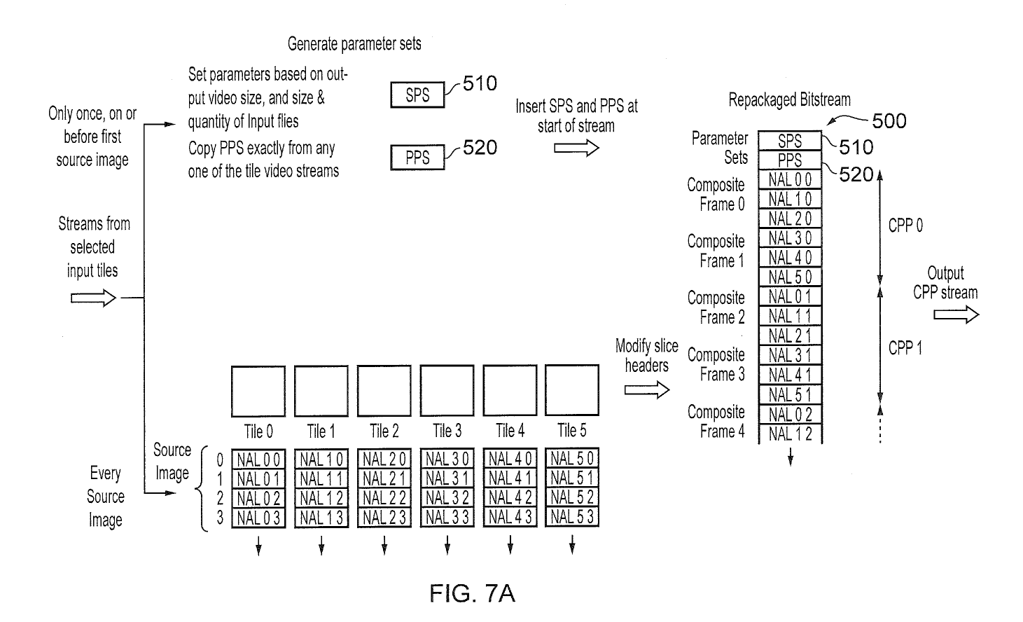

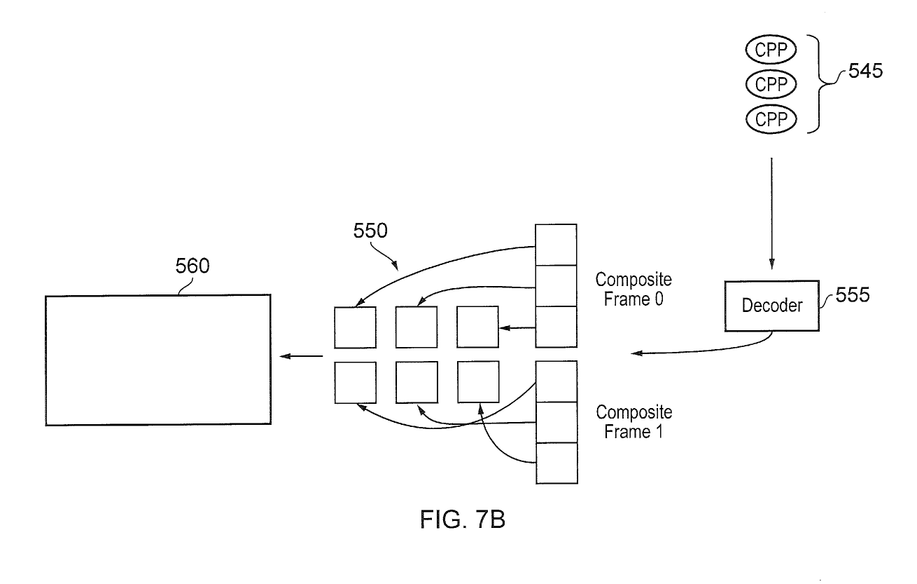

FIGS. 7a and 7b schematically illustrate an example repackaging process showing, schematically, operations carried out by the server 300 (FIG. 7a) and by the client 200 (FIG. 7b). In respect of the currently selected sub-array of tiles (tile 0 . . . tile 5 in this example) and successive source images (source image 0 . . . source image 3 in this example), each tile in each frame is represented by a respective NAL unit (NAL (tile_number, frame_number)).

In respect of the start of a stream, the server generates a Sequence Parameter Set (SPS) 510 and a Picture Parameter Set (PPS) 520, which are then inserted at the start of the stream of CPPs. This process will be discussed further below. These, along with slice header data, provide respective examples of encoding parameter data.

The tiles are repackaged into CPPs so as to form a composite bitstream 500 comprising successive CPPs (CPP 0, CPP 1 . . . ), each corresponding to a respective one of the original source images.

Each CPP comprises one or more composite frames, in each of which, some or all of the tiles of the sub-array are reordered so as to form a composite frame one tile wide and two or more tiles high. So, if just one composite frame is used in each CPP, then the sub-array of tiles is re-ordered into a composite frame one tile wide and a number of tiles in height equal to the number of tiles in the sub-array. If two composite frames are used in each CPP (as in the example of FIG. 7a) then each composite frame will be approximately half as high as the number of tiles in the sub-array (approximately, because the number of tiles in a sub-array may not be exactly divisible by the number of composite frames in each CPP). If n composite frames are used in each CPP, then each composite frame may be one tile wide and approximately equal in height to the number of tiles in the sub array divided by n. In at least some embodiments, the number of tiles provided by each composite frame is the same, to allow for efficient operation at the decoder. If the number of tiles is not exactly divisible by n, dummy or stuffing tiles may be included to provide an even division by n. The reasons for splitting a CPP into multiple composite frames will be discussed below.

Specifically, in the schematic example of FIG. 7a, the sub-array for each source image contains six tiles, Tile 0 . . . Tile 5.

To form a single CPP, the six tiles of the sub-array corresponding to a single respective source image are partitioned into two groups of three tiles:

Tile 0, Tile 1 and Tile 2 form composite frame 0.

Tile 3, Tile 4 and Tile 5 form composite frame 1.

Composite frame 0 and composite frame 1 together form CPP 0.

A similar structure is used for each successive CPP (at least until there is a change in the tiles to be included in the sub-array, for example to implement a change in viewpoint).

Part of the repackaging process involves modifying the slice headers. This process will be discussed further below.

Note that this reordering could in fact be avoided by use of the so-called Flexible Macroblock Ordering (FMO) feature provided in the AVC standard. However, FMO is not well supported and few decoder implementations are capable of handling a bitstream that makes use of this feature.

At the client 200 (FIG. 7b), successive CPPs 545 are received from the server. Each CPP is decoded by a decoder 555 into a respective set of one or more composite frames (frame 0 and frame 1 in the example shown). The composite frames derived from a CPP provide a set of tiles 550 which are rearranged back into the sub-array order to give the display image 560. As noted above, the client device may display the whole of the display image 560 or, in order to allow some degree of panning and other change of view at the client device, the client device may display a subset of the display image 560, optionally with digital zoom applied.

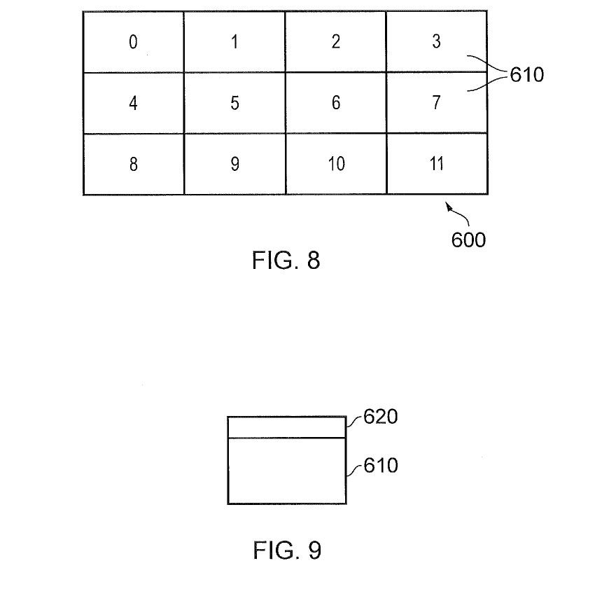

An example will now be described with reference to FIGS. 8 and 9.

FIG. 8 schematically illustrates an example sub-array 600 of 4×3 tiles 610.

FIG. 9 schematically illustrates a tile 610 and associated metadata 620. The metadata may include one or more of: a Sequence Parameter Set (SPS), a Picture Parameter Set (PPS) and slice header information. Some of these metadata may be present in respect of each NAL unit (that is to say, each tile of each frame) but other instances of the metadata such as the SPS and PPS may occur at the beginning of a sequence of tiles. Detailed example contents of the SPS, PPS and slice headers will be discussed by way of example below.

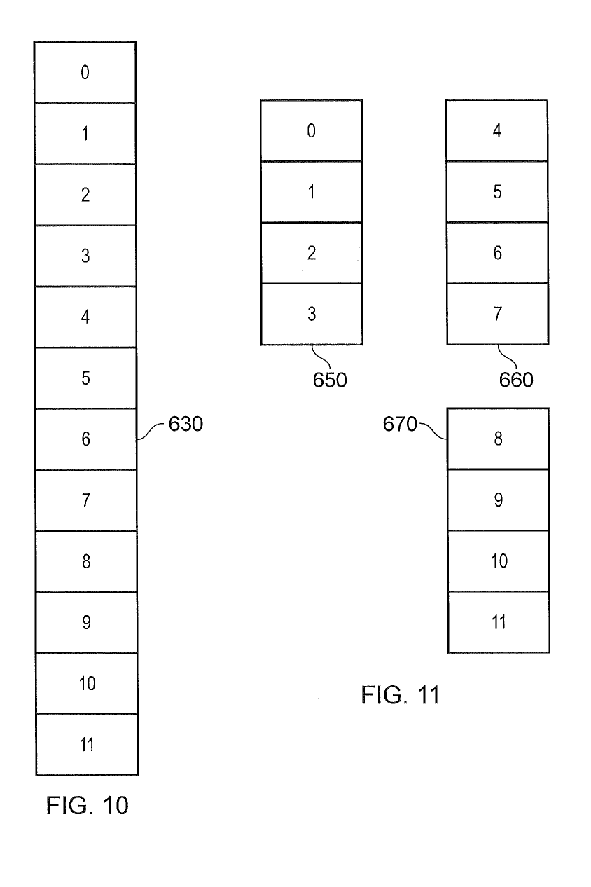

For explanation purposes (to provide a comparison), FIG. 10 schematically illustrates a CPP comprising a single composite frame containing all of the tiles of the sub-array. Each tile is provided as a respective slice of the composite frame. So, in this example the whole sub-array is encoded as a single composite frame formed as an amalgamation one tile wide and (in this example) 12 tiles high using all of the tiles of the sub-array 600 of FIG. 8, and one composite frame is provided as each CPP.

But in the real example given above for an HD output format, 40 tiles are used, each of which is 256 pixels high. If such an arrangement of tiles was combined into a composite picture package of the type shown in FIG. 10, it would be over 10,000 pixels high. This pixel height could exceed a practical limit associated with the processors within at least some mobile devices such as tablet devices, such that the mobile devices could not decode an image of such height. For this reason, other arrangements are used which allow for more than one composite frame to be provided in respect of each CPP.

In the example of FIG. 7a, two composite frames were provided to form each CPP. In another example, shown in FIG. 11, three composite frames are provided within each CPP, namely the composite frames 650, 660, 670. Taken together, these form one CPP.

So, a set of composite frames 650, 660, 670 is formed from the tiles shown in the sub-array 600 of FIG. 8. The 12 tiles of the sub-array 600, namely the tiles 0 . . . 11 are partitioned amongst the three composite frames so that (in this example) the tiles 0 . . . 3 are in the composite frame 650, the tiles 4 . . . 7 are in the composite frame 660 and the tiles 8 . . . 11 are in the composite frame 670. The partitioning may be on the basis of a sequential ordering of the tiles.

In detail, each tile always has its own metadata (the slice header). As for other metadata, it is necessary only to send one set of PPS and SPS (as respective NAL units) even if the tiles are split across multiple composite images.

As mentioned, the contents of the metadata will be discussed below. FIG. 12 is a schematic flowchart illustrating aspects of a process for selecting a sub-array of tiles. In some examples, these operations can be carried out, at least in part, by a video server such as the server 300. However, in other embodiments, partly in order to reduce the processing load on the server, at least some of the operations (or indeed all of the operations shown) may be carried out at the client side. If the server carries out the operations, then it is responsive to information received from the client as to changes in the client view as set, for example, by the user of the client device. If the client carries out the operations, then the client is able to transmit information to the server defining a required set of tiles. In example and non-limiting embodiments, the allocating and modifying steps are carried out at a video server; and the identifying step is carried out at a video client device configured to receive and decode the sets of composite frames from the video server.

In such example embodiments, the client requests a specific sub-array of tiles from the server. The logic described below with reference to FIG. 12 to translate a particular view position into a required set of tiles would be performed at the client device.

Doing this at the client can be better because it potentially reduces the amount of work the server has to do (bearing in mind that the server may be associated with multiple independent clients). It can also aid HTTP caching, because the possible range of request values (in terms of data defining groups of tiles) is finite. The pitch, yaw and zoom that compose a view position are continuous variables that could be different for each client. However, many clients could share similar views that all translate to the same sub-array of tiles. As HTTP caches will only see the request URL (and store the data returned in response), it can be useful to reduce the number of possible requests by having those requests from clients specified as groups of tiles rather than continuously variable viewpoints, so as to improve caching efficiency.

Accordingly, in example embodiments the following steps are performed at the client side.

At a step 700, a sub-array of tiles is selected in respect of a current GOP, as an example of identifying a sub-array of the tiles representing at least a portion of each source image that corresponds to a required display image. At a step 710, a change is detected in the view requested at the client (for example, in respect of user controls operated at the client device) as an example of detecting, in response to operation of a user control, a required portion of the source image and, at a step 720, a detection is made as to whether a newly requested position is within a threshold separation of the edge of the currently selected sub-array. If so, a new sub-array position is selected, but as discussed above the new position is not implemented until the next GOP. At a step 730, if the current GOP has not completed then processing returns to the steps 710 and 720 which are repeated. If, however, the current GOP has completed then processing returns to the step 700 at which a sub-array of tiles is selected in respect of the newly starting GOP.

FIG. 13 is a schematic flowchart illustrating a repackaging process performed at the server 300 (although in other arrangements at least part of the repackaging could be carried out at the client). At a step 740, the sub-array of tiles in respect of the current source image is selected. At a step 750, the set of tiles in the sub-array is partitioned into groups, each group corresponding to a composite frame of the type discussed in respect of FIG. 11. The number of groups is a design decision, but may be selected such that the height in pixels of any such composite frame is within a particular design parameter (for example, corresponding to a maximum allowable image height at an intended type of client device) such as 2000 pixels. The step 750 is an example of allocating tiles of the sub-array of tiles for a source image to respective composite frames of a set of one or more composite frames so that the set of composite frames, taken together, provides image data representing the sub-array of tiles, each composite frame comprising an array of the tiles which is one tile wide by p tiles high, where p is an integer greater than one. At a step 760, metadata such as the SPS and slice headers are changed to reflect the size of each composite frame rather than the size of an individual tile. Also, header data associated with the tiles may be changed to indicate their position within the original sub-array, so that they can be repositioned at decoding. The step 760 is an example of modifying the encoding parameter data associated with the tiles allocated to each composite frame so that the encoding parameter data corresponds to that of a frame of 1×p tiles. At a step 770, the composite frames are packaged as CPPs for transmission to the client device, as an example of transmitting each set of composite frames.

These steps and associated arrangements therefore provide an example of the successive source images each comprising an n×m array of encoded regions, where n and m are respective integers at least one of which is greater than one; each composite frame comprising an array of regions which is q regions wide by p regions high, wherein p and q are integers greater than or equal to one; and q being equal to 1 and p being an integer greater than 1.

The flowchart of FIG. 13 provides an example of a video data encoding method operable with respect to successive source images each comprising a set of encoded regions, each region being separately encoded as an independently decodable network abstraction layer (NAL) unit having associated encoding parameter data; the method comprising:

identifying (for example, at the step 740) a subset of the regions representing at least a portion of each source image that corresponds to a required display image;

allocating (for example, at the step 750) regions of the subset of regions for a source image to respective composite frames of a set of one or more composite frames so that the set of composite frames, taken together, provides image data representing the subset of regions; and

modifying (for example, at the step 760) the encoding parameter data associated with the regions allocated to each composite frame so that the encoding parameter data corresponds to that of a frame comprising those regions allocated to that composite frame.

Note that in at least some embodiments the step 760 can be carried out once in advance of the ongoing operation of the steps 750 and 770. Note that the SPS and/or the PPS can be pre-prepared for a particular output (CPP) format and so may not need to change when the view changes. The slice headers however may need to be changed when the viewpoint (and so the selection of tiles) is changed.

FIG. 14 is a schematic flowchart illustrating aspects of the operation of a video client device. At a step 780 the header information such as the SPS, PPS and slice headers are detected which in turn allows the decoding of the composite frames at a step 790. At a step 800 the decoded tiles are reordered for display, for example according to the detected header data, as an example of generating the display image by reordering the tiles of the decoded input composite frames and displaying each decoded tile according to metadata associated with the tile indicating a display position within the n×m array. Note that in at least some embodiments the SPS and PPS are sent initially to set up the stream and the slice headers are decoded just before the slice data itself is decoded. Accordingly the slice headers are sent with every slice, but the SPS and PPS are sent once at the start of the stream.

The flowchart of FIG. 14 therefore provides an example of a video decoding method comprising:

receiving a set of one or more input composite frames (as an input to the step 780, for example), each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;

decoding (for example, at the step 790) each input composite frame; and

generating the display image from a decoded input composite frame.

Note that the step 800 can provide an example of the generating step. In other embodiments, such as the HEVC-based examples discussed below, the re-ordering aspect of the step 800 is not required, as the composite frames are transmitted in a ready-to-display data order.

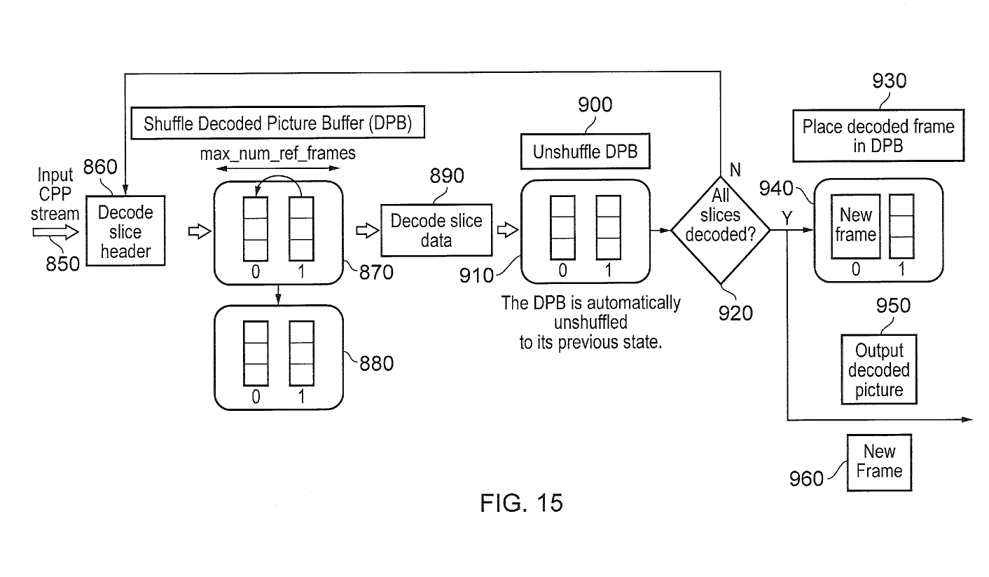

To illustrate decoding at the client device, FIG. 15 schematically illustrates the decoding of CPPs each containing two composite frames (frame 0, frame 1 in FIG. 15), each composite frame containing three tiles. So, the example tile/composite frame/CPP configuration used in FIG. 15 is the same as that used for the schematic discussion of FIGS. 7a and 7b.

Note that this configuration is just an example. In a practical example in which (say) each sub-array contains 40 tiles, a CPP could (for example) be formed of 7 composite frames containing 5 or 6 tiles each (because 40 is not divisible exactly by 7). Alternatively, however, dummy or stuffing tiles are added so as to make the total number divisible by the number of composite frames. So, in this example, two dummy tiles are added to make the total equal to 42, which is divisible by the number of composite frames (7 in this example) to give six tiles in each composite frame. Therefore in example embodiments, the set of composite frames comprises two or more composite frames in respect of each source image, the respective values p being the same or different as between the two or more composite frames in the set.

An input CPP stream 850 is received at the decoder and is handled according to PPS and SPS data received as an initial part of the stream. Each CPP corresponds to a source image. Tiles of the source images were encoded using a particular GOP structure, so this GOP structure is also carried through to the CPPs. Therefore, if the encoding GOP structure was (say) IPPP, then all of the composite frames in a first CPP would be encoded as I frames. Then all of the composite frames in a next CPP would be encoded as P frames, and so on. But what this means in a situation where a CPP contains multiple composite frames is that I and P frames are repeated in the GOP structure. In the present example there are two composite frames in each CPP, so when all of the composite frames are separated out from the CPPs, the composite frame encoding structure is in fact IIPPPPPP . . . . But because (as discussed above) the tiles are all encoded as separate NAL units and are handled within the composite frames as respective slices, the actual dependency of one composite frame to another is determined by which composite frames contain tiles at the same tile position in the original array 50. So, in the example structure under discussion, the third, fifth and seventh P composite frames all have a dependency on the first I composite frame. The fourth, sixth and eighth P composite frames all have a dependency on the second composite I frame. But under a typical approach, the frame buffer at the decoder would normally be emptied each time an I frame was decoded. This would mean (in the present example) that the decoding of the second I frame would cause the first I frame to be discarded, so removing the reference frame for the third, fifth and seventh P composite frames. Therefore, in the present arrangements the buffer at the decoder side has to be treated a little differently.

The slice headers are decoded at a stage 860. It is here that it is specified how the decoded picture buffer will be shuffled, as well as other information such as where the first macroblock in the slice will be positioned.

The decoded composite frames are stored in a decoded picture buffer (DPB), as an example of storing decoded reference frames in a decoder buffer; in which a number of reference frames are stored in the decoder buffer, the number being dependent upon the metadata associated with the set of input composite frames. The DPB has a length (in terms of composite frames) of max_num_ref_frames (part of the header or parameter data), which is 2 in this example. The decoder shuffles (at a shuffling process stage 865) the contents of the DPB so that the decoded composite frame at the back of the DPB is moved to the front (position 0). The rest of the composite frames in the buffer are moved back (away from position 0) by one frame position. This shuffling process is represented schematically by an upper image 870 (as drawn) of the buffer contents showing the shuffling of the previous contents of buffer position 1 into buffer position 0, and the previous contents of buffer position 0 are moved one position further back, which is to say, into buffer position 1. The outcome of this shuffling process is shown schematically in an image 880 of the buffer contents after the process has been carried out. The shuffling process provides an example of changing the order of reference frames stored in the decoder buffer so that a reference frame required for decoding of a next input composite frame is moved, before decoding of part or all of that next input composite frame, is moved to a predetermined position within the decoder buffer. Note that in the embodiments as drawn, the techniques are not applied to bidirectionally predicted (B) frames. If however the techniques were applied to input video that does contain B-frames, then two DPBs could be used. B-frames need to predict from two frames (a past and future frame) and so the system would use another DPB to provide this second reference. Hence there would be a necessity to shuffle both DPBs, rather than the one which is shown being shuffled in FIG. 15.

The DPB we shuffle now is called list 0, the second DPB is called list 1.

The slice data for a current composite frame is decoded at a stage 890. To carry out the decoding, only one reference composite frame is used, which is the frame stored in buffer position 0.

After the decoding stage, the DPB is unshuffled to its previous state at a stage 900, as illustrated by a schematic image 910. At a stage 920, if all slices (tiles) relating to the composite frame currently being decoded have in fact been decoded, then control passes to a stage 930. If not then control passes back to the stage 860 to decode a next slice.

At the stage 930, the newly decoded composite frame is placed in the DPB at position 0, as illustrated by a schematic image 940. The rest of the composite frames are moved back by one position (away from position 0) and the last composite frame in the DPB (the composite frame at a position furthest from position 0) is discarded.

The “yes” outcome of the stage 920 also passes control to a stage 950 at which the newly decoded composite frame 960 is output.

The process discussed above, and in particular the features of (a) setting the variable max_num_ref_frames so as to allow all of the reference frames required for decoding the CPPs to be retained (as an example of modifying metadata defining a number of reference frames applicable to each GOP in dependence upon the number of composite frames provided in respect of each source image), and (b) the shuffling process which places a reference frame at a particular position (such as position 0) of the DPB when that reference frame is required for decoding another frame, mean that the CPP stream as discussed above, in particular a CPP stream in which each CPP is formed of two or more composite frames, can be decoded at an otherwise standard decoder.

These arrangements provide example decoding methods in which one or more of the following apply: the set of regions comprises an array of image regions one region wide by p tiles high; the portion of the source image comprises an array of n×m regions, where n and m are respective integers at least one of which is greater than one; and the generating step comprises reordering the regions of the decoded input composite frames.

These arrangements provide example decoding methods comprising: displaying each decoded region according to metadata associated with the regions indicating a display position within the n×m array.

These arrangements provide example decoding methods in which the input images are encoded as successive groups of pictures (GOPs); the subset of regions represents a sub-portion of a larger image; and the method comprises: issuing an instruction to change a selection of regions included in the subset, in respect of a next GOP.

These arrangements provide example decoding methods in which the set of input composite frames has associated metadata defining a number of reference frames applicable to each GOP.

These arrangements provide example decoding methods in which the decoding step comprises: storing decoded reference frames in a decoder buffer; in which a number of reference frames are stored in the decoder buffer, the number being dependent upon the metadata associated with the set of input composite frames.

These arrangements provide example decoding methods in which the storing step comprises: changing the order of reference frames stored in the decoder buffer so that a reference frame required for decoding of a next input composite frame is moved, before decoding of part or all of that next input composite frame, is moved to a predetermined position within the decoder buffer.

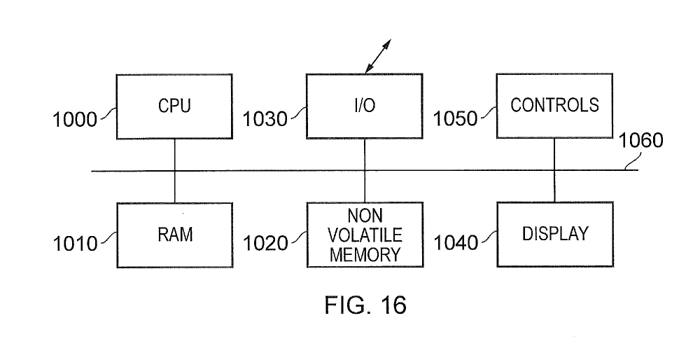

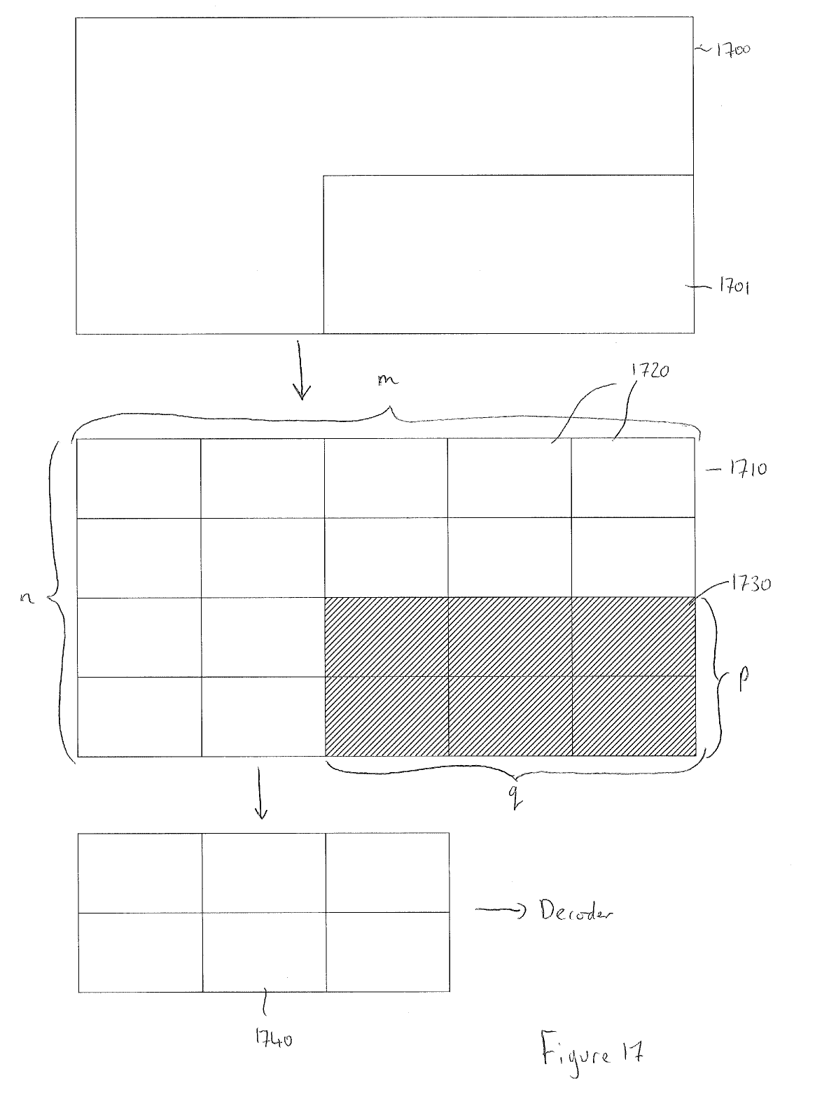

FIG. 16 schematically illustrates a data processing apparatus which may be used as either or both of the server 300 and the client 200. The device of FIG. 16 comprises a central processing unit 1000, random access memory (RAM) 1010, non-volatile memory 1020 such as read-only memory (ROM) and/or a hard disk drive or flash memory, an input/output device 1030 which, for example, may provide a network or other data connection, a display 1040 and one or more user controls 1050, all interconnected by one or more bus connections 1060.

Specific examples of metadata modifications will now be discussed.

The SPS can be sent once or multiple times within a stream. In the present examples, each tile stream is encoded with its own SPS, all of which are identical. For the composite stream, a new SPS can be generated, or one of the existing tile SPS headers can be modified to suit. The SPS can be thought of as something that applies to the stream than the picture. The SPS includes parameters that apply to all pictures that follow it in the stream.

If modifying an existing SPS, it is necessary to change the headers fields pic_width_in_mbs_minus1 (picture width in macroblocks, minus 1) and pic_height_in_map_units_minus1 (picture height in map units, minus 1: see below) to specify the correct picture dimensions in terms of macroblocks. If one source picture is divided into multiple frames, then it is also necessary to modify the field max_num_ref_frames to be N_{ref}=ceil(NH_{T}/H_{F}), where N=number of tiles per picture, H_{T}=tile height, H_{F}=maximum frame height and the function “ceil” indicates a rounding up operation. This ensures that the decoder maintains in its buffers at least N_{ref} reference frames, one for each frame in the composite picture package. Finally, any change to SPS header fields may change the bit length of the header. The header must be byte aligned, which is achieved by modifying the field rbsp_alignment_zero_bit.

| SPS Header field | Description |
|---|---|
| pic_width_in_mbs_minus1 | Width of a tile − 1 |
| pic_height_in_map_units_minus1 | (Height of a tile * |
| | number of tiles) − 1 |
| max_num_ref_frames | If spreading tiles over multiple |
| | composite frames, see function set |
| | out above |
| rbsp_alignment_zero_bit | May need to be extended/shortened |
| | to keep byte alignment |

Much like the SPS, the PPS can be sent multiple times within a stream but at least one instance needs to be sent before any slice data. All slices (or tiles, as one tile is sent in one slice in the present examples) in the same frame must reference the same PPS, as required by the AVC standard. It is not necessary to modify the PPS, so any one of the tile stream PPS headers can be inserted into the composite stream.

More extensive modification is required for the slice headers from each tile. As the slice image data is moved to a new position in the composite frame, the field first_mb_in_slice (first macroblock in slice) must be modified, equal to the tile index (a counter which changes tile by tile) within the frame multiplied by the number of macroblocks in each tile. This provides an example of providing metadata associated with the tiles in a composite frame to define a display position, with respect to the display image, of the tiles. In common with SPS header modification, field changes may change the bit length of the header. For the slice header, cabac_alignment_one_bit may need to be altered to keep the end of the header byte aligned.

Additional changes are required when the CPP is divided into multiple composite frames. Most obviously, the frame number will differ, as each input source image 10 is repackaged into multiple composite frames. The header field frame_num should number each composite frame in the GOP sequentially from 0 to (GOP length*number of composite frames in the CPP) −1. The field ref_pic_list_modification is also altered to specify the correct reference picture for the current composite frame.

The remaining field changes all relate to correct handling of the Instantaneous Decoder Refresh (IDR) flag. Ordinarily, every I-frame is an IDR frame, which means that the decoded picture buffer is cleared. This is undesirable in the present examples, because there are multiple composite frames for each input source image. For example, and as discussed above, if the input GOP length is 4, there might be a GOP structure of I-P-P-P. Each P-frame depends on the previous I-frame (the reference picture), and the decoded picture buffer is cleared every I-frame. If for example the tile streams are repackaged such that tiles from one source image are divided into three composite frames, the corresponding GOP structure would now be III-PPP-PPP-PPP. It is appropriate to ensure that the decoded picture buffer is cleared only on the first I-frame in such a GOP. The first I-frame slice in each GOP is unmodified; subsequent I-frame slices are changed to be non-IDR slices. This requires altering the nal_unit_type and removing the idr_pic_id and dec_ref_pic_list fields.

| Slice header field | Description |
|---|---|
| nal_unit_type | If spreading tiles over multiple composite frames and is |
| | an IDR frame but not frame 0, change to non IDR |
| first_mb_in_slice | Tile index within frame * Tile width in MB * Tile height in MB |
| frame_num | If spreading tiles over multiple composite frames, set to |
| | {(composite frame number) % (GOP length * number |
| | of composite frames in CPP)} |
| idr_pic_id | If spreading tiles over multiple composite frames, and it |
| | is not the first frame in GOP this field needs to be removed |
| ref_pic_list_modification( ) | If spreading tiles over multiple composite frames, |
| | shuffle frame (composite frame number − number of |
| | composite frames in CPP) to front of decoded picture buffer |
| dec_ref_pic_list | If spreading tiles over multiple composite frames and |
| | changing from IDR to non-IDR slice, remove and |
| | replace with 0 |
| cabac_alignment_one_bit | May need to be changed to keep end of header byte aligned |

These modifications as described are all examples of modifying metadata associated with a tile or stream of tiles of a sub-array of tiles so as to correspond to a composite image or stream of composite images each formed as a group of tiles one tile wide and two or more tiles high.

In alternative embodiments, the present video encoding and decoding system is implemented using video compression and decompression according to the HEVC (High Efficiency Video Coding) standard. The following description discusses techniques for operating the apparatus of FIG. 5 in connection with the HEVC standards instead of (as described above) the AVC standards. Note that HEVC and AVC are simply examples and that other encoding and decoding techniques may be used.

Advantageously, the HEVC standard natively supports tiling, such that there is no need for an additional step to split a single image for display across multiple decodable 1×p composite frames to be transmitted. The decoder is therefore not required to run at the higher rate that is required by the AVC implementation discussed above in order to decode the multiple frames corresponding to a single display image. Instead, tiles or other regions corresponding to a required subset of an image can be transmitted as a single HEVC data stream for decoding. This provides an example of a method similar to that described above, in which the allocating step comprises allocating regions of the subset of regions for a source image to a single respective composite frame. As discussed in more detail below, in this case the modifying step may comprise modifying encoding parameter data associated with a first region in the composite frame to indicate that that region is a first region of a frame.

Techniques by which this can be achieved will be discussed below.

FIG. 17 schematically illustrates the encoding process with reference to a source image 1700 with a desired viewing portion (an image for display) 1701, which is described below with reference to a further example use of the data processing apparatus of FIG. 5.

The tile selector and encoder 320 divides images of a source video signal 1700 into multiple regions, such as a contiguous n×m array 1710 of non-overlapping regions 1720, the details of which will be discussed below, which is provided to the data store 310. Note that, as before, the regions do not necessarily have to be rectangular and do not have to be non-overlapping, although regions encoded as HEVC tiles, slices or slice segments would normally be expected to be non-overlapping. The regions are such that each pixel of the original image is included in one (or at least one) respective region. Note also that, as before, the multiple regions do not have to be the same shape or size, and that the term “array” should, in the case of differently-shaped or differently-sized regions, be taken to refer to a contiguous collection of regions rather than a regular arrangement of such regions. The number of regions in total is at least two, but there could be just one region in either or a width or a height direction.

The tile selector and encoder 320 identifies, in response to control data derived from the controls 230 indicating the extent, within the source image, of the required display image, and supplied via the processor 220, a subset 1730 of the regions representing at least a portion of an image in the source video, with the subset corresponding to a required display image. In the present example the subset is a rectangular subset, but in general terms the subset is merely intended at least to encompass a desired display image. The subset could (in some example) be n×m regions where at least one of n and m is greater than one. Note that here, n and m when referring to the subset are usually different to n×m used as variables to describe the whole image, because the subset represents less than the whole image (though, as will be discussed below, from the point of view of a decoder, the subset apparently represents an entire image for decoding). In other words, the repackaged required display image is such that it appears, to the decoder, to be a whole single image for decoding.

The data packager and interface 330 modifies the encoding parameter data associated with the regions to be allocated to the composite frames so that the encoding parameter data corresponds to that of a frame of the identified subset of regions. Such a frame made up of the identified subset of regions may be considered as a “composite frame”. In the present example, by modification of the header data, the whole of such a composite frame can be transmitted as a single HEVC data stream, as though it were a full frame of compressed video data, so the composite frame can also act as a CPP.

More generally, the data packager and interface 330 allocates the selection 1730 of regions 1720 to a set of one or more composite frames 1740 so that the set of composite frames, taken together, provides image data representing the subset of regions. As mentioned above, the subset of regions can be allocated to a single composite frame, as in the present example, but in other examples it could be allocated to multiple composite frames, such as (for example) a composite frame encompassing the upper row (as drawn) of the subset 1730 and another composite frame encompassing the lower row of the subset, with the two composite frames being recombined at the decoder. Each composite frame of the set of one or more composite frames 1740 has a p×q array (in this example, a single 2×3 region composite frame is used) of regions 1720 representing the desired portion 1701 of the source image.

The data packager and interface 330 then transmits, as video data, the composite frames with regions 1720 in the same relative positions as they appear in the source image 1700 to the processor 220. Compared to the AVC embodiments discussed above, this can be considered as simplifying the encoding/decoding process as no rearrangement of the regions 1720 is required.

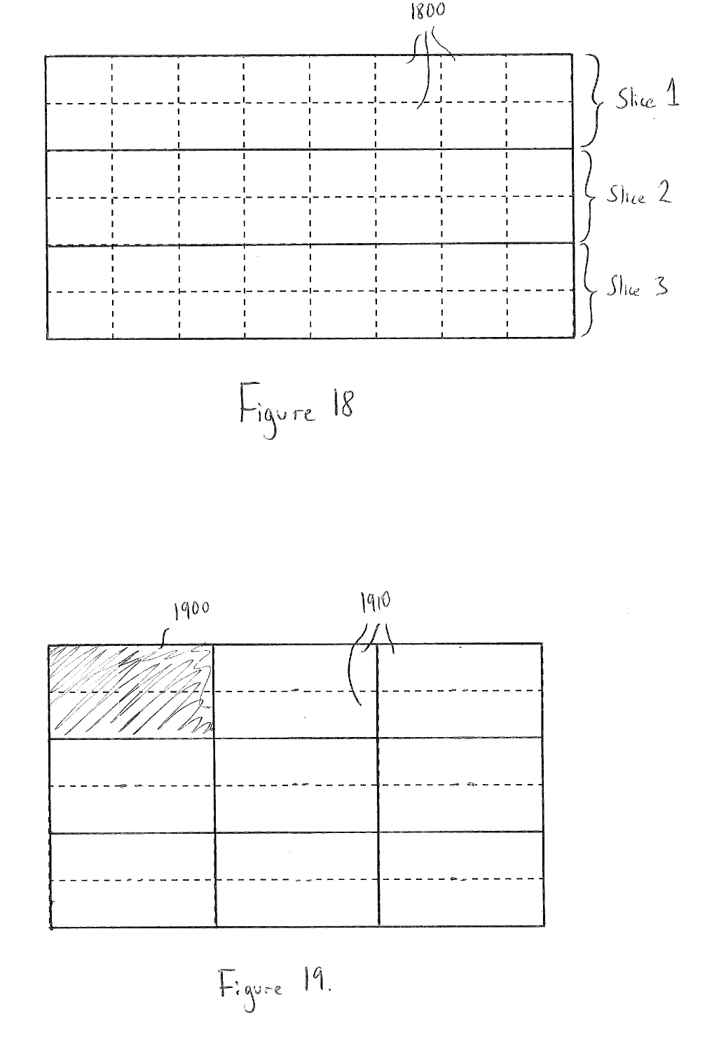

The source video may be divided up into regions in a number of ways, two of which are illustrated as examples in FIGS. 18 and 19.

FIG. 18 schematically illustrates the division of a source image into three slices, labelled for the purposes of this explanation as “slice 1”, “slice 2”, “slice 3”. Although shown to be equal in size, it is possible that the slices are each a different size. Each of these slices is then divided up into a number of tiles 1800. This may be referred to as a tiles-in-slices implementation.

FIG. 19 schematically illustrates the division of a source image into 9 tiles. A shaded area 1900 provides an example of one such tile. Each of these tiles is then divided further into slices 1910. This may be referred to as a slices-in-tiles implementation. As with the slices discussed above, the tiles may each be different sizes rather than all being of a uniform size and distribution in the source image.

Either of these methods of dividing the source image into regions may be used, as long as one or both of the conditions upon each slice and tile, as defined by examples of the HEVC standards, are met:
i. each coding unit in a slice belongs to the same tile; and/or
ii. each coding unit in a tile belongs to the same slice.

The slices and tiles in a single image may each satisfy either of these conditions; it is not essential that each slice and tile in an image satisfies the same conditions.

Depending on how the source image has been divided, the term ‘region’ may therefore refer to a tile, a slice or a slice segment; for example, it is possible in the HEVC implementation that the source image is treated as a single tile and divided into a number of slices and slice segments and it would therefore be inappropriate to refer to the tile as a region of the image. Independently of how the source image is divided, each slice segment corresponds to its own NAL unit. However, dependent on the division, it is also possible that a slice or a tile also corresponds to a single slice segment as a result of the fact that a slice may only have a single slice segment and a slice and a tile can be defined so as to represent the same area of an image.

In order for the decoder to correctly decode the received images in the HEVC implementation, various changes are made by the data packager and interface 330 to headers and parameter sets of the encoded composite frame. (In other embodiments it will be appreciated that the tile selector and encoder 320 can make such changes). It will be appreciated that respective changes are made to each subset 1730 of regions being transmitted. If the apparatus of FIG. 5 is being used to transmit respective different subsets to respective different receivers or groups of receivers then the apparatus makes respective changes to each such subset for transmission.

Slice segment headers contain information about the slice segment with which their respective slice segments are associated. In example embodiments, a single region of the transmitted frame corresponds to a single slice (and a single slice corresponds to a single region), and each slice comprises a number of slice segments. Slice segment headers are therefore modified in order to specify whether the corresponding slice segment is the first in the region of the encoded frame.

This header modification is implemented using the ‘first_slice_segment_in_pic_flag’; this is a flag which is used to indicate the first slice in a picture. If the full input image 1700 of FIG. 17 were being encoded and transmitted in full, this flag would be set in respect of the upper left slice segment of the upper left region as drawn. But in the example of FIG. 17, for transmitting the subset 1730 as a composite frame, this change would be made to the header of the first slice segment of the first (upper left) region in the selection 1730 for transmission. Any subsequent slice segments in the same slice may not include the full header that is associated with the first slice segment of the slice; these subsequent slice segments are known as dependent slice segments.

The picture parameter set (PPS) comprises information about each frame, such as whether tiles are enabled and the arrangement of tiles if they are enabled, and thus may change between successive frames. The PPS should be modified to provide correct information about the arrangement of image regions that have been encoded, as well as enabling tiles. This can be implemented using the following fields in the PPS:

| | |
|---|---|
| tiles_enabled_flag | This flag is used to indicate that the image is |
| | encoded as a number of separate tiles. |
| if(tiles_enabled_flag) { | |
| num_tile_columns_minus1 | Specifies the width of the frame in terms of |
| | the number of tiles, in the example of |
| | FIG. 17 this should be set equal to q − 1 (=2). |
| num_tile_rows_minus1 | Specifies the height of the frame in terms of |
| | the number of tiles, in the example of |
| | FIG. 17 this should be set equal to p − 1 (=1). |

A uniform spacing flag is also present in the PPS, used to indicate that the tiles are all of an equal size. If this is not set, the size of each tile must be set individually in the PPS. There is therefore support for tiles of a number of different sizes within the image.

The effect of enabling tiling is that filtering and prediction is turned off across the boundaries between different tiles of the image; each tile is treated almost as a separate image as a result of this. It is therefore possible to decode each region separately, and in parallel if multiple decoding threads are supported by the decoding device.

Once these changes have been made, the slices are then sent in the correct order for decoding; which is to say the order in which the encoder expects to receive the slices. The process followed at the decoder side is similar to that discussed before, providing an example of a video decoding method comprising: receiving a set of one or more input composite frames, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions; decoding each input composite frame; and generating the display image from a decoded input composite frame.

As a specific example of metadata or parameter changes, the following is provided:

### SPS

| Parameter to change | What to change it to |
|---|---|
| pic_width_in_luma_samples | Total width of picture |
| pic_height_in_luma_samples | Total height of picture |
| rbsp_trailing_bits | To an appropriate value to keep header |
| | byte aligned after changing above |
| | parameters |

### PPS

| Parameter to change | What to change it to |
|---|---|
| num_tile_columns_minus1 | Number of tile columns being sent minus 1 |
| num_tile_rows_minus1 | Number of tile rows being sent minus 1 |
| uniform_spacing_flag | If all columns are of equal width, and all |
| | rows of equal height, this can be set true. |
| column_width_minus1[i] | If non-uniform spacing, set to column |
| | width of column i. Otherwise does not |
| | need to exist. |
| row_height_minus1[i] | If non-uniform spacing, set to row height |
| | of row i. Otherwise does not need to exist. |
| rbsp_trailing_bits | To an appropriate value to keep header |
| | byte aligned after changing above |
| | parameters |

### SLICE

| Parameter to change | What to change it to |
|---|---|
| first_slice_segment_in_pic_flag | If it is the first slice in the picture, set to |
| | true. Otherwise, false. |
| slice_segment_address | If first_slice_segment_in_pic_flag is |
| | true, remove it. Otherwise change to the |
| | total number of CTUs preceding it. (Tile |
| | scan order addressing) |
| rbsp_trailing_bits | To an appropriate value to keep header |
| | byte aligned after changing above |
| | parameters |

In addition, in at least some examples, loop filtering is not used across tiles, and tiling is enabled.

Data Signals

It will be appreciated that data signals generated by the variants of coding apparatus discussed above, and storage or transmission media carrying such signals, are considered to represent embodiments of the present disclosure.

It will be appreciated that all of the techniques and apparatus described may be implemented in hardware, in software running on a general-purpose data processing apparatus such as a general-purpose computer, as programmable hardware such as an application specific integrated circuit (ASIC) or field programmable gate array (FPGA) or as combinations of these. In cases where the embodiments are implemented by software and/or firmware, it will be appreciated that such software and/or firmware, and non-transitory machine-readable data storage media by which such software and/or firmware are stored or otherwise provided, are considered as embodiments.

Respective aspects and features of the present disclosure are defined by the following numbered clauses:

1. A video data encoding method operable with respect to successive source images each comprising an array of n×m encoded tiles, where n and m are respective integers at least one of which is greater than one, each tile being separately encoded as an independently decodable network abstraction layer (NAL) unit having associated encoding parameter data; the method comprising:

identifying a sub-array of the tiles representing at least a portion of each source image that corresponds to a required display image;

allocating tiles of the sub-array of tiles for a source image to respective composite frames of a set of one or more composite frames so that the set of composite frames, taken together, provides image data representing the sub-array of tiles, each composite frame comprising an array of the tiles which is one tile wide by p tiles high, where p is an integer greater than one; and

modifying the encoding parameter data associated with the tiles allocated to each composite frame so that the encoding parameter data corresponds to that of a frame of 1×p tiles.

2. A method according to clause 1, comprising transmitting each set of composite frames.
3. A method according to clause 1 or clause 2, comprising providing metadata associated with the tiles in a composite frame to define a display position, with respect to the display image, of the tiles.
4. A method according to clause 1, in which:

the source images are encoded as successive groups of pictures (GOPs);

the method comprising:

carrying out the identifying step in respect of each GOP so that within a GOP, the same sub-array is used in respect of each source image encoded by that GOP.

5. A method according to any one of the preceding clauses, in which the identifying step comprises:

detecting, in response to operation of a user control, the portion of the source image; and

detecting the sub-array of tiles so that the part of the source image represented by the sub-array is larger than the detected portion.

6. A method according to any one of the preceding clauses, in which:

the allocating and modifying steps are carried out at a video server; and

the identifying step is carried out at a video client device configured to receive and decode the sets of composite frames from the video server.

7. A method according to clause 4, in which:

the set of composite frames comprises two or more composite frames in respect of each source image, the respective values p being the same or different as between the two or more composite frames in the set.

8. A method according to clause 7, in which the modifying step comprises modifying metadata defining a number of reference frames applicable to each GOP in dependence upon the number of composite frames provided in respect of each source image.
9. A video decoding method comprising:

receiving a set of one or more input composite frames, each input composite frame comprising an array of image tiles one tile wide by p tiles high, each tile being separately encoded as an independently decodable network abstraction layer (NAL) unit, in which the tiles provided by the set of input frames, taken together, represent at least a portion, corresponding to a required display image, of a source image of a video signal comprising an array of n×m tiles, where n and m are respective integers at least one of which is greater than one;

decoding each input composite frame; and

generating the display image by reordering the tiles of the decoded input composite frames.

10. A method according to clause 9, comprising:

displaying each decoded tile according to metadata associated with the tile indicating a display position within the n×m array.

11. A method according to clause 9 or clause 10, in which:

the input images are encoded as successive groups of pictures (GOPs);

the array of tiles represents a sub-portion of a larger image; and

the method comprises:

issuing an instruction to change a selection of tiles included in the array, in respect of a next GOP.

12. A method according to clause 11, in which the set of input composite frames has associated metadata defining a number of reference frames applicable to each GOP.
13. A method according to clause 12, in which the decoding step comprises:

storing decoded reference frames in a decoder buffer;

in which a number of reference frames are stored in the decoder buffer, the number being dependent upon the metadata associated with the set of input composite frames.

14. A method according to clause 13, in which the storing step comprises:

changing the order of reference frames stored in the decoder buffer so that a reference frame required for decoding of a next input composite frame is moved, before decoding of part or all of that next input composite frame, is moved to a predetermined position within the decoder buffer.

15. Computer software which, when executed by a computer, causes a computer to perform the method of any of the preceding clauses.
16. A non-transitory machine-readable storage medium which stores computer software according to clause 15.
17. Video data encoding apparatus operable with respect to successive source images each comprising an array of n×m encoded tiles, where n and m are respective integers at least one of which is greater than one, each tile being separately encoded as an independently decodable network abstraction layer (NAL) unit having associated encoding parameter data; the apparatus comprising:

a sub-array selector configured to identify a sub-array of the tiles representing at least a portion of each source image that corresponds to a required display image;

a frame allocator configured to allocate tiles of the sub-array of tiles for a source image to respective composite frames of a set of one or more composite frames so that the set of composite frames, taken together, provides image data representing the sub-array of tiles, each output frame comprising an array of the tiles which is one tile wide by p tiles high, where p is an integer greater than one; and

a data modifier configured to modify the encoding parameter data associated with the tiles allocated to each composite frame so that the encoding parameter data corresponds to that of a frame of 1×p tiles.

18. A video decoder comprising:

a data receiver configured to receive a set of one or more input composite frames, each input composite frame comprising an array of image tiles one tile wide by p tiles high, each tile being separately encoded as an independently decodable network abstraction layer (NAL) unit, in which the tiles provided by the set of input composite frames, taken together, represent at least a portion, corresponding to a required display image, of a source image of a video signal comprising an array of n×m tiles, where n and m are respective integers at least one of which is greater than one;

a decoder configured to decode each input frame; and

an image generator configured to generate the display image by reordering the tiles of the decoded input composite frames.

Further respective aspects and features of the present disclosure are defined by the following numbered clauses:

1. A video data encoding method operable with respect to successive source images each comprising a set of encoded regions, each region being separately encoded as an independently decodable network abstraction layer (NAL) unit having associated encoding parameter data; the method comprising:

identifying a subset of the regions representing at least a portion of each source image that corresponds to a required display image;

allocating regions of the subset of regions for a source image to respective composite frames of a set of one or more composite frames so that the set of composite frames, taken together, provides image data representing the subset of regions; and

modifying the encoding parameter data associated with the regions allocated to each composite frame so that the encoding parameter data corresponds to that of a frame comprising those regions allocated to that composite frame.

2. A method according to clause 1, comprising transmitting each of the composite frames.
3. A method according to clause 1 or clause 2, in which:

the source images are encoded as successive groups of pictures (GOPs);

the method comprising:

carrying out the identifying step in respect of each GOP so that within a GOP, the same subset is used in respect of each source image encoded by that GOP.

4. A method according to any one of the preceding clauses, in which the identifying step comprises:

detecting, in response to operation of a user control, the portion of the source image; and

detecting the subset of regions so that the part of the source image represented by the subset is larger than the detected portion.

5. A method according to any one of the preceding clauses, in which:

the allocating and modifying steps are carried out at a video server; and

the identifying step is carried out at a video client device configured to receive and decode the composite frames from the video server.

6. A method according to any one of the preceding clauses, in which the successive source images each comprise an n×m array of encoded regions, where n and m are respective integers at least one of which is greater than one.
7. A method according to any one of the preceding clauses, in which each composite frame comprises an array of regions which is q regions wide by p regions high, wherein p and q are integers greater than or equal to one.
8. A method according to clause 7, in which q is equal to 1 and p is an integer greater than 1.
9. A method according to clause 8, comprising providing metadata associated with the regions in a composite frame to define a display position, with respect to the display image, of the regions.
10. A method according to clause 8 or clause 9, in which:

the set of composite frames comprises two or more composite frames in respect of each source image, the respective values p being the same or different as between the two or more composite frames in the set.

11. A method according to clause 10, in which the modifying step comprises modifying metadata defining a number of reference frames applicable to each GOP in dependence upon the number of composite frames provided in respect of each source image.
12. A method according to any one of clauses 1 to 6, in which the allocating step comprises allocating regions of the subset of regions for a source image to a single respective composite frame.
13. A method according to clause 12, in which the modifying step comprises modifying encoding parameter data associated with a first region in the composite frame to indicate that that region is a first region of a frame.
14. A video decoding method comprising:

receiving a set of one or more input composite frames, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;

decoding each input composite frame; and

generating the display image from a decoded input composite frame.

15. A method according to clause 14, in which:

the set of regions comprises an array of image regions one region wide by p tiles high;

the portion of the source image comprises an array of n×m regions, where n and m are respective integers at least one of which is greater than one; and

the generating step comprises reordering the regions of the decoded input composite frames.

16. A method according to clause 15, comprising:

displaying each decoded region according to metadata associated with the regions indicating a display position within the n×m array.

17. A method according to any one of clauses 14 to 16, in which:

the input images are encoded as successive groups of pictures (GOPs);

the portion represents a sub-portion of a larger image; and

the method comprises:

issuing an instruction to change a selection of regions included in the subset, in respect of a next GOP.

18. A method according to clause 17, in which the set of input composite frames has associated metadata defining a number of reference frames applicable to each GOP.
19. A method according to clause 18, in which the decoding step comprises:

storing decoded reference frames in a decoder buffer;

in which a number of reference frames are stored in the decoder buffer, the number being dependent upon the metadata associated with the set of input composite frames.

20. A method according to clause 19, in which the storing step comprises:

changing the order of reference frames stored in the decoder buffer so that a reference frame required for decoding of a next input composite frame is moved, before decoding of part or all of that next input composite frame, is moved to a predetermined position within the decoder buffer.

21. A non-transitory machine-readable storage medium which stores computer software which, when executed by a computer, causes a computer to perform the method of clause 1.
22. A non-transitory machine-readable storage medium which stores computer software which, when executed by a computer, causes a computer to perform the method of clause 14.
23. Video data encoding apparatus operable with respect to successive source images each comprising a set of encoded regions, each region being separately encoded as an independently decodable network abstraction layer (NAL) unit having associated encoding parameter data; the apparatus comprising:

a subset selector configured to identify a subset of the regions representing at least a portion of each source image that corresponds to a required display image;

a frame allocator configured to allocate regions of the subset of regions for a source image to respective composite frames of a set of one or more composite frames so that the set of composite frames, taken together, provides image data representing the subset of regions, each output frame comprising a subset of the regions; and

a data modifier configured to modify the encoding parameter data associated with the regions allocated to the composite frames so that the encoding parameter data corresponds to that of a frame comprising those regions allocated to that composite frame.

24. A video decoder comprising:

a data receiver configured to receive a set of one or more input composite frames, each input composite frame comprising a group of image regions, each region being separately encoded as an independently decodable network abstraction layer (NAL) unit, in which the regions provided by the set of input composite frames, taken together, represent at least a portion, corresponding to a required display image, of a source image of a video signal comprising a set of regions;

a decoder configured to decode each input frame; and

an image generator configured to generate the display image from a decoded input frame.

25. A method of operation of a video client device comprising:

receiving a set of one or more input composite frames from a server, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;

decoding each input composite frame;

generating the display image from a decoded input composite frame; and

in response to a user input, sending information to the server indicating the extent, within the source image, of the required display image.

26. A method according to clause 25, in which:

the set of regions comprises an array of image regions one region wide by p tiles high;

the portion of the source image comprises an array of n×m regions, where n and m are respective integers at least one of which is greater than one; and

the generating step comprises reordering the regions of the decoded input composite frames.

27. A method according to clause 26, comprising:

displaying each decoded region according to metadata associated with the regions indicating a display position within the n×m array.

28. A method according to clause 25, in which:

the input images are encoded as successive groups of pictures (GOPs);

the subset of regions represents a sub-portion of a larger image; and

the sending step comprises:

issuing an instruction to change a selection of regions included in the subset, in respect of a next GOP.

29. A method according to clause 28, in which the set of input composite frames has associated metadata defining a number of reference frames applicable to each GOP.
30. A method according to clause 29, in which the decoding step comprises:

storing decoded reference frames in a decoder buffer;

in which a number of reference frames are stored in the decoder buffer, the number being dependent upon the metadata associated with the set of input composite frames.

31. A method according to clause 30, in which the storing step comprises:

changing the order of reference frames stored in the decoder buffer so that a reference frame required for decoding of a next input composite frame is moved, before decoding of part or all of that next input composite frame, is moved to a predetermined position within the decoder buffer.

32. A video client device comprising:

a data receiver configured to receive a set of one or more input composite frames from a server, each input composite frame comprising a group of image regions, each region being separately encoded as an independently decodable network abstraction layer (NAL) unit, in which the regions provided by the set of input composite frames, taken together, represent at least a portion, corresponding to a required display image, of a source image of a video signal comprising a set of regions;

a decoder configured to decode each input frame;

an image generator configured to generate the display image from a decoded input frame; and

a controller, responsive to a user input, configured to send information to the server indicating the extent, within the source image, of the required display image.

1: A video data encoding method operable with respect to successive source images each comprising a set of encoded regions, each region being separately encoded as an independently decodable network abstraction layer (NAL) unit having associated encoding parameter data; the method comprising:
identifying a subset of the regions representing at least a portion of each source image that corresponds to a required display image;
allocating regions of the subset of regions for a source image to respective composite frames of a set of one or more composite frames so that the set of composite frames, taken together, provides image data representing the subset of regions; and
modifying the encoding parameter data associated with the regions allocated to each composite frame so that the encoding parameter data corresponds to that of a frame comprising those regions allocated to that composite frame.

2: The method according to claim 1, comprising transmitting each of the composite frames.

3: The method according to claim 1, in which:
the source images are encoded as successive groups of pictures (GOPs);
the method comprising:
carrying out the identifying step in respect of each GOP so that within a GOP, the same subset is used in respect of each source image encoded by that GOP.

4: The method according to claim 1, in which the identifying step comprises:
detecting, in response to operation of a user control, the portion of the source image; and
detecting the subset of regions so that the part of the source image represented by the subset is larger than the detected portion.

5: The method according to claim 1, in which:
the allocating and modifying steps are carried out at a video server; and
the identifying step is carried out at a video client device configured to receive and decode the composite frames from the video server.

6: The method according to claim 1, in which the successive source images each comprise an n×m array of encoded regions, where n and m are respective integers at least one of which is greater than one.

7: The method according to claim 1, in which each composite frame comprises an array of regions which is q regions wide by p regions high, wherein p and q are integers greater than or equal to one.

8: The method according to claim 7, in which q is equal to 1 and p is an integer greater than 1.

9: The method according to claim 8, comprising providing metadata associated with the regions in a composite frame to define a display position, with respect to the display image, of the regions.

10: The method according to claim 8, in which:
the set of composite frames comprises two or more composite frames in respect of each source image, the respective values p being the same or different as between the two or more composite frames in the set.

11: The method according to claim 10, in which the modifying step comprises modifying metadata defining a number of reference frames applicable to each GOP in dependence upon the number of composite frames provided in respect of each source image.

12: The method according to claim 1, in which the allocating step comprises allocating regions of the subset of regions for a source image to a single respective composite frame.

13: The method according to claim 12, in which the modifying step comprises modifying encoding parameter data associated with a first region in the composite frame to indicate that that region is a first region of a frame.

14: The method of operation of a video client device comprising:
receiving a set of one or more input composite frames from a server, each input composite frame comprising a group of image regions, each region being separately encoded as an independently decodable network abstraction layer (NAL) unit, in which the regions provided by the set of input frames, taken together, represent at least a portion, corresponding to a required display image, of a source image of a video signal comprising a set of regions;
decoding each input composite frame;
generating the display image from a decoded input composite frame; and
in response to a user input, sending information to the server indicating the extent, within the source image, of the required display image.

15: The method according to claim 14, in which:
the set of regions comprises an array of image regions one region wide by p tiles high;
the portion of the source image comprises an array of n×m regions, where n and m are respective integers at least one of which is greater than one; and
the generating step comprises reordering the regions of the decoded input composite frames.

16: The method according to claim 15, comprising:
displaying each decoded region according to metadata associated with the regions indicating a display position within the n×m array.

17: The method according to claim 14, in which:
the input images are encoded as successive groups of pictures (GOPs);
the subset of regions represents a sub-portion of a larger image; and
the sending step comprises:
issuing an instruction to change a selection of regions included in the subset, in respect of a next GOP.

18: The method according to claim 17, in which the set of input composite frames has associated metadata defining a number of reference frames applicable to each GOP.

19: The method according to claim 18, in which the decoding step comprises:
storing decoded reference frames in a decoder buffer;
in which a number of reference frames are stored in the decoder buffer, the number being dependent upon the metadata associated with the set of input composite frames.

20-23. (canceled)

24: A video client device comprising:
a data receiver configured to receive a set of one or more input composite frames from a server, each input composite frame comprising a group of image regions, each region being separately encoded as an independently decodable network abstraction layer (NAL) unit, in which the regions provided by the set of input composite frames, taken together, represent at least a portion, corresponding to a required display image, of a source image of a video signal comprising a set of regions;
a decoder configured to decode each input frame;
an image generator configured to generate the display image from a decoded input frame; and
a controller, responsive to a user input, configured to send information to the server indicating the extent, within the source image, of the required display image.
